(19) United States
(12) Patent Application Publication
(10) Pub. No.: US 2020/0288102 A1
(43) Pub. Date: Sep. 10, 2020

(54) IMAGE PROCESSING METHOD AND APPARATUS

(71) Applicant: Electronics and Telecommunications Research Institute, Daejeon (KR)

(72) Inventors: Gi Mun UM, Seoul (KR); Joung Il YUN, Daejeon (KR)

(73) Assignee: Electronics and Telecommunications Research Institute, Daejeon (KR)

(21) Appl. No.: 16/799,086

(22) Filed: Feb. 24, 2020

(30) Foreign Application Priority Data
Mar. 6, 2019 (KR) 10-2019-0026005

(51) Int. Cl. H04N 13/128; H04N 13/111; H04N 13/282; G06T 17/00

(52) U.S. Cl. CPC H04N 13/128; H04N 13/111; H04N 2013/0081; G06T 17/00; H04N 13/282

(57) ABSTRACT

Provided are an image processing method and apparatus for generating a three-dimensional (3D) virtual viewpoint image by combining multi-view depth map on a 3D space through depth clustering. In the image processing method and apparatus, pieces of color and depth information are stored in units of depth clusters to minimize influences of occlusion regions and holes during generating of the virtual viewpoint image.

### CROSS-REFERENCE TO RELATED APPLICATION

This application claims priority to and the benefit of Korean Patent Application No. 2019-0026005, filed on Mar. 6, 2019, the disclosure of which is incorporated herein by reference in its entirety.

### BACKGROUND

### 1. Field of the Invention

Various embodiments set forth herein relate to a technique for creating a three-dimensional (3D) virtual viewpoint image.

### 2. Discussion of Related Art

Electronic devices may generate a sense of depth of a three-dimensional (3D) image using parallax between images of different viewpoints. To create a multi-view image, an electronic device may generate a virtual viewpoint image from left and right color images and a depth image or through rendering on the basis of images of three or more viewpoints.

In such an electronic device of the related art, a depth error is likely to occur during matching of left and right images for extracting depth information or during extracting of depth information from an image with many similar color regions.

In addition, a multi-view image may include occlusion regions in which a pixel seen in an image of one viewpoint is not seen in an image of another viewpoint, and pixels having intermittent depths between multiple viewpoint images.

Accordingly, the quality of an intermediate viewpoint image generated by the electronic device decreases due to artifacts and holes caused by the occlusion regions and incorrect calculation of parallax information about depth-discontinuity region

### SUMMARY OF THE INVENTION

To address the above problem, various embodiments set forth herein provide an image processing method and apparatus for generating a three-dimensional (3D) virtual viewpoint image by combining multi-view depth map in a 3D space through depth clustering.

The above-described aspects, other aspects, advantages and features of various embodiments set forth herein and methods of achieving them will be apparent from embodiments described below in detail in conjunction with the accompanying drawings.

In one embodiment, an image processing method includes obtaining a multi-view depth map of a plurality of viewpoint images and determining depth reliability of each point on the multi-view depth map, mapping each of the plurality of viewpoint images to a three-dimensional (3D) point cloud on a reference coordinate system, generating at least one depth cluster by performing depth clustering of each 3D point on the 3D point cloud on the basis of the depth reliability, and creating a virtual viewpoint image by projecting each 3D point on the 3D point cloud to a virtual viewpoint for each depth cluster.

In one embodiment, a depth clustering-based image processing method includes mapping a plurality of viewpoint images to a three-dimensional (3D) point cloud on a 3D coordinate space and generating at least one depth cluster by grouping each 3D point on the basis of depth reliability and a chrominance of each 3D point on the 3D point cloud while moving an XY plane perpendicular to a depth axis of the 3D coordinate space along the depth axis.

In one embodiment, an image processing apparatus includes a plurality of cameras configured to capture images of different viewpoints, and a processor, wherein the processor is configured to obtain a multi-view depth map of a plurality of viewpoint images and determine depth reliability of each point on the multi-view depth map, map each of the plurality of viewpoint images to a three-dimensional (3D) point cloud on a reference coordinate system, generate at least one depth cluster by performing depth clustering of each 3D point on the 3D point cloud on the basis of the depth reliability, and create a virtual viewpoint image by projecting each 3D point on the 3D point cloud to a virtual viewpoint for each depth cluster.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 schematically illustrates an image processing system according to an embodiment;

FIG. 2 is a flowchart of an image processing method according to an embodiment;

FIG. 3 is a flowchart of specific examples of operations of the image processing method;

FIG. 4 is a flowchart of an example of a depth clustering process; and

FIG. 5 is a block diagram of an image processing apparatus according to an embodiment.

### DETAILED DESCRIPTION OF EXEMPLARY EMBODIMENTS

Aspects of the present disclosure will be described with reference to embodiments set forth herein. It will be apparent that the present disclosure is not limited to these embodiments and may be embodied in many different forms within the scope of the technical idea of the present disclosure. The terms used herein are for the purpose of describing the embodiments only and are not intended to be limiting to the present disclosure. As used herein, singular forms are intended to include plural forms unless the context clearly indicates otherwise. As used herein, the terms “comprise” and/or “comprising” specify the presence of stated components, steps, operations and/or elements but do not preclude the presence or addition of one or more other components, steps, operations and/or elements.

Hereinafter, the configuration of the present disclosure will be described in detail with reference to the exemplary embodiments and in conjunction with the accompanying drawings. The above-described aspects, other aspects, advantages and features of the present disclosure and methods of achieving them will be apparent from the following description of the embodiments described below in detail in conjunction with the accompanying drawings.

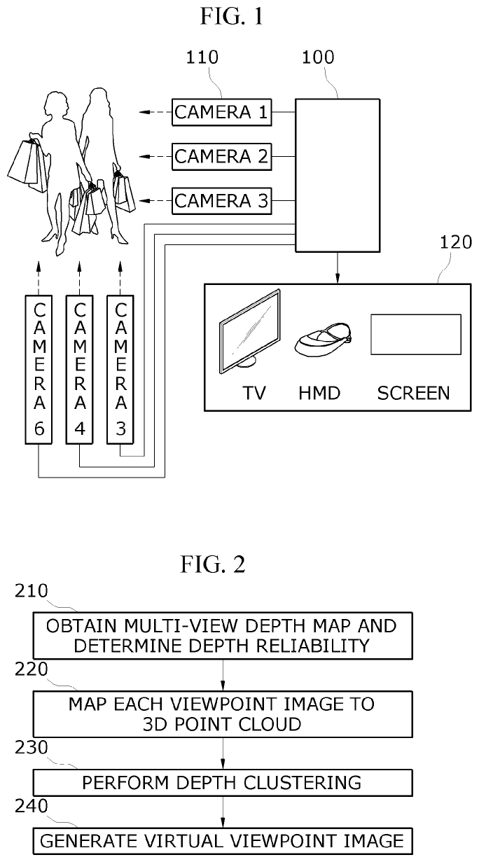

FIG. 1 schematically illustrates an image processing system according to an embodiment.

The image processing system according to the embodiment includes an image processing apparatus 100, a plurality of cameras 110, and an output device 120.

The plurality of cameras 110 are a group of cameras arranged at different viewpoint positions and include a group of cameras arranged in a line or a two-dimensional (2D) array. In addition, the plurality of cameras 110 may include at least one depth camera (or a camera capable of obtaining depth information).

The image processing apparatus 100 may receive a multi-view image captured by the plurality of cameras 110, perform an image processing method according to an embodiment, and transmit, to the output device 120, a three-dimensional (3D) image obtained as a result of performing the image processing method. The image processing method according to an embodiment will be described with reference to FIGS. 2 to 4 below.

FIG. 2 is a flowchart of an image processing method according to an embodiment.

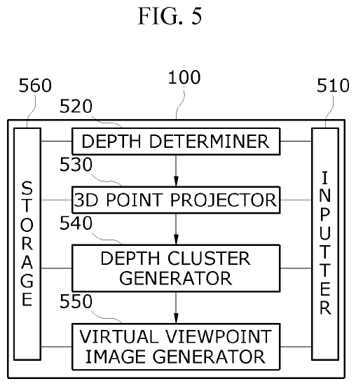

Referring to FIGS. 2 and 5, an inputter 510 of the image processing apparatus 100 may provide the image processing apparatus 100 with a plurality of viewpoint images captured from different viewpoints.

In operation 210, a depth determiner 520 of the image processing apparatus 100 of FIG. 5 obtains a multi-view depth map of the plurality of viewpoint images received from the inputter 510 and determines the depth reliability of each point on the multi-view depth map.

The plurality of viewpoint images include a plurality of images of different viewpoints. The depth determiner 520 generates a depth map for each of the plurality of viewpoint images. The depth map of each of the plurality of viewpoint images refers to, for example, either an image in which a depth value representing a distance to a surface of an object to be photographed when viewed from an observation point is stored for each point (for example, a pixel) on each of the plurality of viewpoint images or a channel of the image. The multi-view depth map refers to, for example, a set of depth maps of images of different viewpoints. The depth determiner 520 generates a multi-view depth map based on the plurality of viewpoint images or receives an externally generated multi-view depth map via the inputter 510. When the depth determiner 520 generates a multi-view depth map, a depth value obtained by a depth camera may be used and/or a disparity value obtained through stereo matching of multi-view images captured by a plurality of cameras is converted into a depth value and the depth value is used.

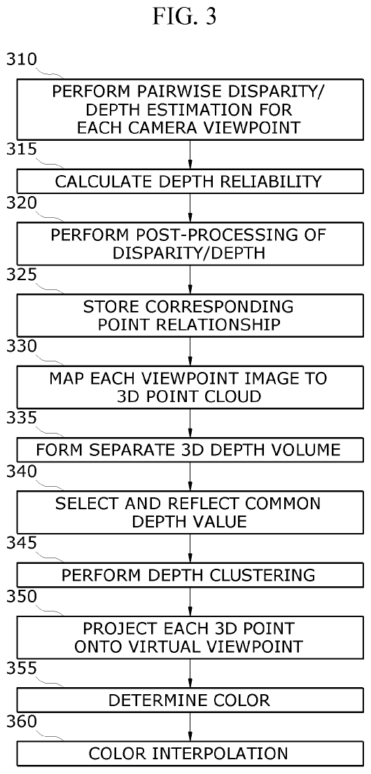

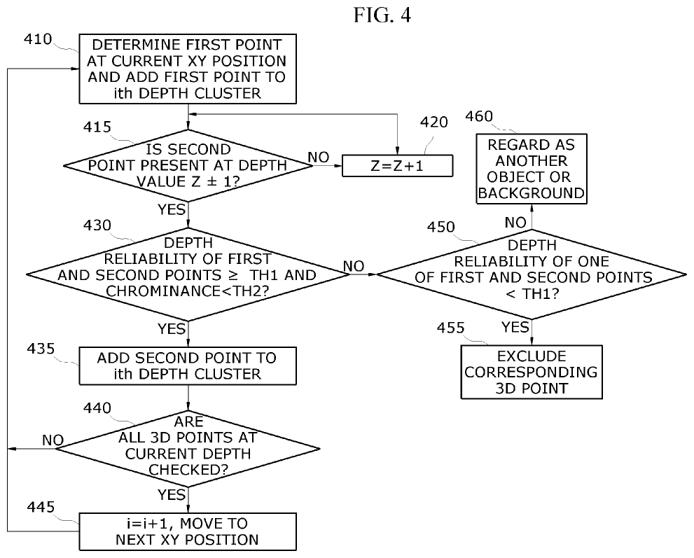

The depth reliability of each point on the multi-view depth map refers to the reliability of a depth value of each point. The determination of the depth reliability will be described with reference to FIG. 3 below.

In operation 220, a 3D point projector 530 of the image processing apparatus 100 of FIG. 5 maps each of the plurality of viewpoint images to a 3D point cloud on a reference coordinate system. For example, in operation 220, the 3D point projector 530 maps the plurality of viewpoint images to a 3D point cloud in a 3D coordinate space.

The 3D point cloud is a set of 3D points mapped to the 3D coordinate space and includes all points in the plurality of viewpoint images.

In operation 230, a depth cluster generator 540 of the image processing apparatus 100 of FIG. 5 generates at least one depth cluster by performing depth clustering of each 3D point on the 3D point cloud mapped in operation 220 based on the depth reliability determined in operation 210. For example, the depth cluster generator 540 generates at least one depth cluster by grouping each 3D point on the basis of the depth reliability and a chrominance of each 3D point on the 3D point cloud mapped in operation 220 while moving an XY plane perpendicular to a depth axis of the 3D coordinate space along the depth axis. Depth clustering will be described with reference to FIG. 4 below.

In operation 240, a virtual viewpoint image generator 550 of the image processing apparatus 100 of FIG. 5 generates a virtual viewpoint image by projecting each 3D point on the 3D point cloud to a virtual viewpoint for each depth cluster generated in operation 230.

The virtual viewpoint image refers to an image of an object viewed from a virtual viewpoint and is an image of a virtual viewpoint generated from a multi-view image, which is actually captured by a plurality of cameras, but is not actually captured. For example, the virtual viewpoint image includes an intermediate viewpoint image obtained when an object is viewed from an intermediate viewpoint between cameras.

FIG. 3 is a flowchart of examples of operations of the image processing method. The operations illustrated in FIG. 3 will be described with reference to the image processing apparatus of FIG. 5.

In operation 310, the depth determiner 520 obtains a multi-view depth map of a plurality of viewpoint images. In addition, the depth determiner 520 generates a disparity map for each of the plurality of viewpoint images.

When the depth determiner 520 determines a depth map or a disparity map, the depth determiner 520 generates a disparity map or a depth map by estimating a disparity value through stereo matching for pairwise matching the plurality of viewpoints. For example, the depth determiner 520 may perform stereo matching on two adjacent viewpoint images of the plurality of viewpoint images. In an alternative example, the depth determiner 520 may perform stereo matching on all pairs of two different viewpoint images of the plurality of viewpoint images. Alternatively, the depth determiner 520 may receive a multi-view depth map or a disparity map via the inputter 510.

In operation 315, the depth determiner 520 determines the depth reliability of each point on the multi-view depth map. In addition, the depth determiner 520 determines the reliability of disparity of each point on the multi-view disparity map.

The depth reliability is a similarity between corresponding points detected by matching every two viewpoint images of the plurality of viewpoint images. For example, the depth reliability is a value representing a degree of matching between corresponding points on a pair of viewpoint images.

When every two viewpoint images among the plurality of viewpoint images are stereo matched, the depth determiner 520 selects a portion of a second image as a search region to identify a second point on the second image corresponding to a first point on a first image. Each point on the selected search region is a candidate point that is likely to be the second point. The depth determiner 520 calculates a similarity between a candidate point and the first point according to a predetermined similarity function and determines a candidate point having the highest similarity among points having a similarity higher than a predetermined threshold. Here, the similarity function is a function for calculation of a similarity between two points by comparing, for example, a color similarity, a color distribution, and/or gradient values of a pair of corresponding points. Similarly, the depth determiner 520 determines the reliability of disparity of each point on the disparity map.

In one example, operations 310 and 315 may be performed simultaneously.

In operation 320, the depth determiner 520 performs post-processing of the disparity map or the depth map obtained in operation 310. For example, in operation 320, the depth determiner 520 detects occlusion regions by performing a left-right (L-R) consistency check and generates a mask in which each point on the detected occlusion regions is represented as a binary value. For example, in the L-R consistency check, a consistency check is alternately performed on a right image for a left image and the left image for the right image. The depth determiner 520 may remove mismatching disparities or depths, which occurs during matching of every two viewpoint images among the plurality of viewpoint images, using the generated mask. For example, operation 320 may be selectively performed. Operation 320 may be omitted, for example, depending on settings.

In operation 325, the depth determiner 520 determines a corresponding point relationship between the plurality of viewpoint images. The corresponding point relationship refers to the relationship between a first point on a first viewpoint image and a second point on a second viewpoint image, which is most similar to the first point, in operation 315 of determining the depth reliability. For example, a point corresponding to the first point on the second viewpoint image is the second point. Similarly, a third point on a third viewpoint image, which has a corresponding point relationship with the second point of the second viewpoint image, is determined. For example, when the plurality of viewpoint images include N viewpoint images, the first point on the first viewpoint image, the second point on the second viewpoint image, the third point on the third viewpoint image, and an N^{th} point on an N^{th} viewpoint image are in the corresponding point relationship. For example, the corresponding point relationship is defined with respect to the plurality of viewpoint images. As another example, a plurality of points on a plurality of viewpoint images may be connected according to the corresponding point relationship. The corresponding point relationship is expressed, for example, in the form of a linked list or a tree structure.

Alternatively, the depth determiner 520 determines a corresponding point relationship between the plurality of viewpoint images in operation 315 and stores the corresponding point relationship in operation 325.

In operation 330, the 3D point projector 530 maps each viewpoint image to a 3D point cloud on a reference coordinate system.

In detail, the 3D point projector 530 converts coordinates of each point on the multi-view depth map to 3D coordinates of the reference coordinate system based on camera information. Here, the multi-view depth map is determined in operation 310 and selectively post-processed in operation 320. The camera information includes, for example, a mutual positional relationship between a plurality of cameras used to capture a plurality of viewpoint images, location information of the cameras, pose (information of the cameras, and baseline length information. For example, the camera information may be obtained through camera calibration. As another example, the 3D point projector 530 converts coordinates of each point on a multi-view depth map obtained through conversion of a multi-view disparity map to 3D coordinates of the reference coordinate system.

Alternatively, the 3D point projector 530 may directly convert the coordinates of each point on the multi-view disparity map to 3D coordinates of the reference coordinate system. For example, in operation 330, the 3D point projector 530 projects each point on the disparity map to the reference coordinate system using each information about a camera used to photograph point on the disparity map. Here, the disparity map is determined in operation 310 and selectively post-processed in operation 320.

The reference coordinate system refers to a 3D coordinate system of a reference image. The reference image is an image used as a reference for defining a 3D coordinate system to be used for 3D point cloud mapping among a plurality of viewpoint images. For example, the reference image is a center view image. The reference image may be determined according to extracted camera information. For example, the reference image is a viewpoint image captured by a camera located centrally among the plurality of cameras based on the extracted camera information.

Thereafter, the 3D point projector 530 maps each point on each viewpoint image to a 3D point cloud on the reference coordinate system according to the converted 3D coordinates. Thus, the plurality of viewpoint images are integrated and mapped into a 3D point cloud in a 3D space. For example, the 3D point projector 530 maps the multi-view depth map to the 3D point cloud on the reference coordinate system based on the camera information.

In operation 335, the 3D point projector 530 divides the 3D point cloud mapped in operation 330 into a plurality of depth units on the basis of the reference image. The depth units are fixed constants or adjustable variables.

The 3D point cloud being divided the depth units forms a separate 3D depth volume. For example, the 3D depth volume is a voxel space which is in a cuboidal form.

The depth units may be related to units of depth clustering described with reference to operation 345 below. For example, in operation 345, depth clustering is performed in a unit of a voxel space divided according to the depth units. In operation 345, as the depth units increase, depth clustering is performed on 3D points of a range of deeper depth values. For example, when the depth units are 8 bits, a depth of the divided voxel space ranges from 0 to 255, and depth clustering is performed on 3D points in the voxel space. Therefore, one depth cluster is generated for one voxel space divided according to the depth units.

In operation 340, the 3D point projector 530 selects a common depth value of points corresponding to each other according to the corresponding point relationship determined in operation 325.

For example, the 3D point projector 530 selects, as a common depth value, a depth value with the largest number of votes among depth values of the corresponding points according to the corresponding point relationship. To this end, the 3D point projector 530 performs depth value voting on the corresponding points on the plurality of viewpoint images and selects a depth value with the largest number of votes as a common depth value. For example, the 3D point projector 530 counts the number of times a depth value of the corresponding points appears and selects a depth value appearing most frequently as a common depth value. As another example, the 3D point projector 530 selects, as a common depth value, a depth value with the highest depth reliability among the depth values of the corresponding points.

In operation 340, the 3D point projector 530 reflects the selected common depth value in the 3D point cloud mapped in operation 330.

In operation 345, the depth cluster generator 540 generates at least one depth cluster by performing depth clustering of each 3D point on the 3D point cloud based on the depth reliability calculated in operation 315. For example, the depth cluster generator 540 generates a depth cluster by performing depth clustering while increasing a depth value z for an (x,y) position of each 3D point on a 3D point cloud mapped in a 3D space until there are no 3D points mapped to overlap each other in a direction of a depth axis. A depth clustering process will be described in detail with reference to FIG. 4 below.

FIG. 4 is a flowchart of an example of a depth clustering process.

In operation 410, the depth cluster generator 540 adds, to a first depth cluster, a first point on an XY plane perpendicular to a depth axis of a reference coordinate system. For example, the depth cluster generator 540 increases a depth value Z of zero until a first point is found at a current XY position on the XY plane. When the first point is found, the depth cluster generator 540 creates a new cluster to add the first point to the new cluster. Also, the total number of clusters and the number of 3D points on the new cluster are increased by one. In other words, the depth cluster generator 540 generates at least one depth cluster by grouping each point while moving the XY plane along the depth axis to increase the depth value Z.

In operation 415, the depth cluster generator 540 finds a second point having the same XY coordinates as the first point while moving the XY plane along the depth axis. In operation 420, the depth value Z is increased until a second point having the same XY coordinates as the first point is found. For example, the depth cluster generator 540 determines whether a second point having the same XY coordinates is present at a depth value Z±1 of the first point in operation 415 and increases the depth value Z until the second point is found in operation 420.

A process of the depth cluster generator 540 searching for the second point in operation 415 may be understood as searching for the second point having the same XY coordinates with the first point while moving the XY plane along the depth axis to increase the depth value Z.

When it is determined in operation 415 that the second point is present, in operation 430, the depth cluster generator 540 determines whether the depth reliability of the first point and the second point is greater than or equal to a reference reliability (condition 1) and determines whether the chrominance between the first point and the second point is less than a reference chrominance (condition 2).

When it is determined in operation 430 that the first point and the second point satisfy both of the conditions 1 and 2, in operation 435, the depth cluster generator 540 adds the second point to the first depth cluster to which the first point is added. For example, the depth reliability of the first point and the depth reliability of second points and colors of the first and second points are compared with each other, and the second point is added to the first depth cluster to which the first point belongs when the depth reliability of the first and second points is greater than or equal to a threshold Th₁ and the chrominance between the first and second points is less than a threshold Th₂.

In operation 450, when the depth reliability of at least one of the first and second points is less than the reference reliability, the depth cluster generator 540 does not add the at least one of the first and second points to a depth cluster. For example, when the depth reliability of any one of the first and second points is less than the threshold Th₁, the depth cluster generator 540 removes the at least one of the first and second points with lower depth reliability without adding them to a depth cluster.

In operation 460, the depth cluster generator 540 does not add the second point to the first depth cluster when the depth reliability of both the first point and the second point is greater than or equal to the reference reliability and the chrominance between the first point and the second point is greater than or equal to the reference chrominance. In this case, the depth cluster generator 540 regards the second point as either a 3D point belonging to an object different from that of the first point or a background and thus does not add the second point to a current depth cluster.

In operation 440, the depth cluster generator 540 determines whether all 3D points at a current depth are checked. When it is determined in operation 440 that an unchecked 3D point is present at the current depth, the process returns to operation 410.

When it is determined in operation 440 that all the 3D points at the current depth are checked, the depth cluster generator 540 checks whether unchecked 3D points are present at the current XY position. When unchecked 3D points are present at the current XY position, the depth cluster generator 540 moves to a higher depth and returns to operation 410. In this case, the depth cluster generator 540 resets the depth value Z to zero and performs operation 410.

When there are no unchecked 3D points at the current XY position, in operation 445, the depth cluster generator 540 moves to a next XY position and returns to operation 410. In this case, the depth value Z is reset to zero and operation 410 is performed. Operations 410 to 460 are repeatedly performed until there are no unchecked 3D points at the current XY position.

The depth cluster generator 540 ends depth clustering of operation 345 when new clusters are not created anymore and there are no unchecked 3D points mapped to the 3D point cloud or checking of 3D points at the farthest depth is completed.

Referring back to FIG. 3, in operation 350, the virtual viewpoint image generator 550 projects each 3D point on the 3D point cloud to a virtual viewpoint for each depth cluster generated in operation 345.

In operation 350, the virtual viewpoint image generator 550 projects each 3D point on the 3D point cloud to the virtual viewpoint for each depth cluster generated in operation 345 along a direction in which the depth value of the at least one depth cluster is decreased. For example, in operation 350, after the depth clustering of operation 345 is completed, the virtual viewpoint image generator 550 sequentially projects, toward a higher-depth cluster starting from a lower-depth cluster, each 3D point on the 3D point cloud to a corresponding virtual viewpoint for each of the at least one depth cluster in a virtual viewpoint direction. Similarly, in the same cluster, each 3D point is projected to a virtual viewpoint in a direction from a lower-depth 3D point to a higher-depth 3D point. 3D points are projected to virtual viewpoints in units of clusters, starting from a lower-depth cluster, and thus, virtual viewpoint images are created in the order of a background, a far object, and a near object. Accordingly, an image processing apparatus according to an embodiment is capable of effectively packing occlusion regions or a hole.

In operation 355, the virtual viewpoint image generator 550 determines color of each 3D point projected to the virtual viewpoint in operation 350. When a plurality of 3D points are projected to the same XY position of a virtual viewpoint image, the virtual viewpoint image generator 550 selects 3D points, the depth reliability of which is greater than or equal to a reference reliability Th₁ among the plurality of 3D points. The virtual viewpoint image generator 550 identifies two 3D points with lower depth values among the selected 3D points, and determines, as a color at the XY position, a color of a preceding 3D point in the virtual viewpoint direction (or a 3D point with a smaller depth value) among the two 3D points when the difference in depth between the two 3D points is greater than or equal to a reference depth value Th₃. Meanwhile, when the difference in depth between the two 3D points is less than the reference depth value Th₃, a color obtained by blending colors of the two 3D points is determined as the color of the XY position using the reliabilities of depth of the two 3D points as weights.

In operation 360, the virtual viewpoint image generator 550 interpolates color of a non-projected 3D point on the virtual viewpoint image generated through operations 350 and 355 with color of the farthest 3D point in a virtual viewpoint direction among the projected 3D points on the virtual viewpoint image. As another example, the virtual viewpoint image generator 550 may interpolate color of a non-projected 3D point with color obtained by blending colors of points filling the vicinity of the non-projected 3D point by using a distance to the filling points to the non-projected 3D point as a weight. Alternatively, the color of the non-projected 3D point may be interpolated by an inpainting technique.

FIG. 5 is a block diagram of an image processing apparatus according to an embodiment. The image processing apparatus 100 includes a plurality of cameras for capturing images of different viewpoints. In another example, the image processing apparatus 100 does not include a plurality of cameras and obtains a plurality of viewpoint images, which are captured by a plurality of external cameras, through a network and the inputter 510. According to various embodiments, the image processing apparatus 100 may include a plurality of cameras.

The inputter 510 may include a communication circuit configured to transmit a plurality of viewpoint images to or receive a plurality of viewpoint images from the plurality of cameras. The communication circuit may establish communication via a network employing a communication method, e.g., a local area network (LAN), fiber-to-the home (FTTH), x-Digital Subscriber Line (xDSL), WiFi, Wibro, 3G, or 4G.

A storage 560 may store various types of data used by at least one component (e.g., a processor) of the image processing apparatus 100. The data may include, for example, input data or output data for software and commands related thereto.

The image processing apparatus 100 includes a processor (not shown). For example, the processor includes at least one microprocessor such as a central processing unit (CPU) or a graphics processing unit (GPU).

The processor executes the depth determiner 520 that obtains a multi-view depth map of a plurality of viewpoint images received through the inputter 510 and determines the depth reliability of each point on the multi-view depth map.

The processor executes the 3D point projector 530 that maps each point on each viewpoint image to a 3D point cloud on a reference coordinate system.

The processor executes the depth cluster generator 540 that generates at least one depth cluster by performing depth clustering of each 3D point on the 3D point cloud on the basis of the depth reliability.

The processor executes the virtual viewpoint image generator 550 that generates a virtual viewpoint image by projecting each 3D point on the 3D point cloud to a virtual viewpoint for each depth cluster.

The image processing apparatus 100 includes the storage 560. For example, the storage 560 stores a plurality of viewpoint images, depth maps, disparity maps, corresponding point relationships, 3D point clouds, depth cluster information, and information related to virtual viewpoint images.

In an image processing method and apparatus according to the present disclosure, an accurate and realistic virtual viewpoint image may be created by mapping a multi-color image and a depth image to a 3D space on the basis of a reference viewpoint image and combining the multi-color image and the depth image by performing depth reliability-based depth voting and depth clustering to minimize influences of occlusion regions and holes.

According to various embodiments of the present disclosure, at least one depth cluster may be generated in a 3D space, and pieces of color and depth information can be stored for each depth cluster to minimize artifacts in a hole region during generation of a virtual viewpoint image.

In addition, according to the various embodiments set forth herein, a 3D virtual viewpoint image is created by combining a multi-color image and a depth map through depth clustering, thereby minimizing an occlusion region and improving the quality of a 3D image.

The image processing method and apparatus according to an embodiment of the present disclosure may be implemented in a computer system or recorded on a recording medium. The computer system may include at least one processor, a memory, a user input device, a data communication bus, a user output device, and storage. Each of the above components may establish data communication with one another via the data communication bus.

The computer system may further include a network interface coupled to a network. The processor may be a CPU or a semiconductor device for processing instructions stored in the memory and/or the storage.

The memory and the storage may include various forms of volatile or nonvolatile storage media. For example, the memory may include a read-only memory (ROM) and a random access memory (RAM).

Therefore, the image processing method according to the embodiment of the present disclosure may be implemented by a computer executable method. When the image processing method according to the embodiment of the present disclosure is performed by a computer device, the image processing method may be performed using computer readable instructions.

The above-described image processing method according to the present disclosure may be embodied as computer-readable code on a computer-readable recording medium. The non-transitory computer-readable recording medium should be understood to include all types of recording media storing data interpretable by a computer system. Examples of the non-transitory computer-readable recording medium include a ROM, a RAM, magnetic tape, a magnetic disk, a flash memory, an optical data storage device, and so on. The non-transitory computer-readable recording medium can also be distributed over computer systems connected via a computer network and can be stored and implemented as code readable in a distributed fashion.

According to an embodiment, an image processing method includes obtaining a multi-view depth map of a plurality of viewpoint images and determining depth reliability of each point on the multi-view depth map; mapping each of the plurality of viewpoint images to a three-dimensional (3D) point cloud on a reference coordinate system; generating at least one depth cluster by performing depth clustering of each 3D point on the 3D point cloud on the basis of the depth reliability; and creating a virtual viewpoint image by projecting each 3D point on the 3D point cloud to a virtual viewpoint for each depth cluster.

The depth reliability comprises a similarity between corresponding points found by matching every two viewpoint images among the plurality of viewpoint images.

The image processing method further includes determining a corresponding point relationship between the plurality of viewpoint images; selecting a common depth value of points corresponding to each other according to the corresponding point relationship; and reflecting the common depth value in the 3D point cloud.

The selecting of the common depth value comprises selecting, as the common depth value, either a depth value with a largest number of votes or a depth value with a highest depth reliability among depth values of the points.

The mapping of each of the plurality of viewpoint images to the 3D point cloud comprises mapping the multi-view depth map to the 3D point cloud on the reference coordinate system on the basis of camera information.

The generating of the at least one depth cluster includes adding a first point on an XY plane perpendicular to a depth axis of the reference coordinate system to a first depth cluster; searching for a second point having the same XY coordinates as the first point while moving the XY plane along the depth axis; and adding the second point to the first depth cluster when the depth reliability of the first point and the second point are greater than or equal to reference reliability and a chrominance between the first point and the second point is less than a reference chrominance.

The generating of the at least one depth cluster further comprises not adding the second point to the first depth cluster when the depth reliability of at least one of the first point and the second point is less than the reference reliability or when the depth reliability of both the first point and the second point is greater than or equal to the reference reliability and the chrominance between the first point and the second point is greater than or equal to the reference chrominance.

The searching for the second point comprises searching for the second point having the same XY coordinates as the first point while moving the XY plane along the depth axis to increase a depth value.

The generating of the virtual viewpoint image comprises projecting each 3D point on the 3D point cloud to the virtual viewpoint for each depth cluster along a direction in which the depth value of the at least one depth cluster is decreased.

The generating of the virtual viewpoint image includes when a plurality of 3D points are projected to the same XY position on the virtual viewpoint image, selecting 3D points with depth reliability greater than or equal to reference reliability among the plurality of 3D points; and identifying two 3D points with lower depth values among the selected 3D points, and determining, as a color at the XY position, a color of a preceding 3D point in a direction of the virtual viewpoint among the two 3D points when a difference in depth between the two 3D points is greater than or equal to a reference depth difference.

The generating of the virtual viewpoint image includes when a plurality of 3D points are projected to the same XY position on the virtual viewpoint image, selecting 3D points with depth reliability greater than or equal to reference reliability among the plurality of 3D points; and identifying two 3D points with lower depth values among the selected 3D points, and determining, as a color at the XY position, a color obtained by blending colors of the two 3D points using the depth reliability of the two 3D points as a weight when a difference in depth between the two 3D points is less than a reference depth difference.

The generating of the virtual viewpoint image comprises interpolating a color of a non-projected 3D point on the generated virtual viewpoint image with a color of a farthest 3D point in a direction of the virtual viewpoint among the 3D points projected onto the virtual viewpoint image.

According to an embodiment, a depth clustering-based image processing method includes mapping a plurality of viewpoint images to a three-dimensional (3D) point cloud on a 3D coordinate space; and generating at least one depth cluster by grouping each 3D point on the basis of depth reliability and a chrominance of each 3D point on the 3D point cloud while moving an XY plane perpendicular to a depth axis of the 3D coordinate space along the depth axis.

The generating of the at least one depth cluster comprises generating the at least one depth cluster by grouping each point while moving the XY plane along the depth axis to increase a depth value.

According to an embodiment, an image processing apparatus includes a plurality of cameras configured to capture images of different viewpoints; and a processor, wherein the processor is configured to obtain a multi-view depth map of a plurality of viewpoint images and determine depth reliability of each point on the multi-view depth map; map each of the plurality of viewpoint images to a three-dimensional (3D) point cloud on a reference coordinate system; generate at least one depth cluster by performing depth clustering of each 3D point on the 3D point cloud on the basis of the depth reliability; and create a virtual viewpoint image by projecting each 3D point on the 3D point cloud to a virtual viewpoint for each depth cluster.

The present disclosure has been described above with reference to the embodiments thereof. It will be understood by those of ordinary skill in the art that various modifications or changes may be made in the present disclosure without departing from essential features of the present disclosure. Therefore, the embodiments set forth herein should be considered in a descriptive sense only and not for purposes of limitation. The scope of the present disclosure is set forth in the claims rather than in the foregoing description, and all differences falling within a scope equivalent thereto should be construed as being included in the present disclosure.

What is claimed is:

1. An image processing method comprising:
obtaining a multi-view depth map of a plurality of viewpoint images and determining depth reliability of each point on the multi-view depth map;
mapping each of the plurality of viewpoint images to a three-dimensional (3D) point cloud on a reference coordinate system;
generating at least one depth cluster by performing depth clustering of each 3D point on the 3D point cloud on the basis of the depth reliability; and
creating a virtual viewpoint image by projecting each 3D point on the 3D point cloud to a virtual viewpoint for each depth cluster.

2. The image processing method of claim 1, wherein the depth reliability comprises a similarity between corresponding points found by matching every two viewpoint images among the plurality of viewpoint images.

3. The image processing method of claim 1, further comprising:
determining a corresponding point relationship between the plurality of viewpoint images;
selecting a common depth value of points corresponding to each other according to the corresponding point relationship; and
reflecting the common depth value in the 3D point cloud.

4. The image processing method of claim 3, wherein the selecting of the common depth value comprises selecting, as the common depth value, either a depth value with a largest number of votes or a depth value with a highest depth reliability among depth values of the points.

5. The image processing method of claim 1, wherein the mapping of each of the plurality of viewpoint images to the 3D point cloud comprises mapping the multi-view depth map to the 3D point cloud on the reference coordinate system on the basis of camera information.

6. The image processing method of claim 1, wherein the generating of the at least one depth cluster comprises:
adding a first point on an XY plane perpendicular to a depth axis of the reference coordinate system to a first depth cluster;
searching for a second point having the same XY coordinates as the first point while moving the XY plane along the depth axis; and
adding the second point to the first depth cluster when the depth reliability of the first point and the second point are greater than or equal to reference reliability and a chrominance between the first point and the second point is less than a reference chrominance.

7. The image processing method of claim 6, wherein the generating of the at least one depth cluster further comprises not adding the second point to the first depth cluster when the depth reliability of at least one of the first point and the second point is less than the reference reliability or when the depth reliability of both the first point and the second point is greater than or equal to the reference reliability and the chrominance between the first point and the second point is greater than or equal to the reference chrominance.

8. The image processing method of claim 6, wherein the searching for the second point comprises searching for the second point having the same XY coordinates as the first point while moving the XY plane along the depth axis to increase a depth value.

9. The image processing method of claim 1, wherein the generating of the virtual viewpoint image comprises projecting each 3D point on the 3D point cloud to the virtual viewpoint for each depth cluster along a direction in which the depth value of the at least one depth cluster is decreased.

10. The image processing method of claim 1, wherein the generating of the virtual viewpoint image comprises:
when a plurality of 3D points are projected to the same XY position on the virtual viewpoint image, selecting 3D points with depth reliability greater than or equal to reference reliability among the plurality of 3D points; and
identifying two 3D points with lower depth values among the selected 3D points, and determining, as a color at the XY position, a color of a preceding 3D point in a direction of the virtual viewpoint among the two 3D points when a difference in depth between the two 3D points is greater than or equal to a reference depth difference.

11. The image processing method of claim 1, wherein the generating of the virtual viewpoint image comprises:
when a plurality of 3D points are projected to the same XY position on the virtual viewpoint image, selecting 3D points with depth reliability greater than or equal to reference reliability among the plurality of 3D points; and
identifying two 3D points with lower depth values among the selected 3D points, and determining, as a color at the XY position, a color obtained by blending colors of the two 3D points using the depth reliability of the two 3D points as a weight when a difference in depth between the two 3D points is less than a reference depth difference.

12. The image processing method of claim 1, wherein the generating of the virtual viewpoint image comprises interpolating a color of a non-projected 3D point on the generated virtual viewpoint image with a color of a farthest 3D point in a direction of the virtual viewpoint among the 3D points projected onto the virtual viewpoint image.

13. A depth clustering-based image processing method comprising:
mapping a plurality of viewpoint images to a three-dimensional (3D) point cloud on a 3D coordinate space; and
generating at least one depth cluster by grouping each 3D point on the basis of depth reliability and a chrominance of each 3D point on the 3D point cloud while moving an XY plane perpendicular to a depth axis of the 3D coordinate space along the depth axis.

14. The image processing method of claim 13, wherein the generating of the at least one depth cluster comprises generating the at least one depth cluster by grouping each point while moving the XY plane along the depth axis to increase a depth value.

15. An image processing apparatus comprising:
a plurality of cameras configured to capture images of different viewpoints; and
a processor,
wherein the processor is configured to:
obtain a multi-view depth map of a plurality of viewpoint images and determine depth reliability of each point on the multi-view depth map;
map each of the plurality of viewpoint images to a three-dimensional (3D) point cloud on a reference coordinate system;
generate at least one depth cluster by performing depth clustering of each 3D point on the 3D point cloud on the basis of the depth reliability; and
create a virtual viewpoint image by projecting each 3D point on the 3D point cloud to a virtual viewpoint for each depth cluster.
